(19) United States
(12) Patent Application Publication
(10) Pub. No.: US 2007/0187651 A1
(43) Pub. Date: Aug. 16, 2007

(54) Method for mixing powder, agitation apparatus, and method for manufacturing honeycomb structured body

(76) Inventors: Kazuya Naruse, Courtenay (FR); Eiji Sumiya, Gifu (JP); Kosei Tajima, Gifu (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/636,460

(22) Filed: Dec. 11, 2006

(30) Foreign Application Priority Data
Dec. 26, 2005 (JP) PCT/JP05/23813

(51) Int. Cl. H01B 1/12

(52) U.S. Cl. 252/500

(57) ABSTRACT

A method for mixing powder according to the present invention is a method for mixing powder by conducting mixing and transporting of at least one kind of powder, comprising: charging said at least one kind of powder into an agitation apparatus; and translating said at least one kind of powder while mixing the powder by rotating an agitation shaft of said agitation apparatus, said agitation apparatus comprising: a screw comprised of the agitation shaft and an agitating blade, said screw configured to rotate along with the said agitation shaft as the center; and, a casing surrounding said screw, wherein either the entire body of said agitating blade is formed of a high hardness member, or, a high hardness coat layer is formed onto at least a portion of said agitating blade.

### CROSS-REFERENCE TO RELATED APPLICATIONS

This application claims priority of PCT/JP2005/023813 filed on Dec. 26, 2005. The contents of this application are incorporated herein by reference in their entirety.

### BACKGROUND OF THE INVENTION

1. Field of the Invention

The present invention relates to a method for mixing powder, an agitation apparatus, and a method for manufacturing honeycomb structured body.

2. Discussion of the Background

Harm to the environment and the human body caused by particulates such as soot contained in exhaust gas discharged from the internal combustion engines of buses, trucks and other vehicles, construction equipment and the like has recently become a problem. For that reason, there have been currently proposed numerous kinds of honeycomb filters using a honeycomb structured body of porous ceramic as a filter for capturing particulates contained in exhaust gas, thereby purifying the exhaust gas.

FIG. 1 is a perspective view schematically showing an example of an embodiment of such a honeycomb structured body. FIG. 2A is a perspective view schematically showing a honeycomb fired body which comprises the honeycomb structured body according to the above-mentioned embodiment, while FIG. 2B is a A-A line cross-sectional view of the therein.

In a honeycomb structured body 130, a plurality of honeycomb fired bodies 140, of the kind shown in FIGS. 2A and 2B, are combined with one another by interposing a sealing material layer (adhesive layer) 131 forming a ceramic block 133, and a sealing material layer (coat layer) 132 is formed on the periphery of the ceramic block 133.

And comprising the honeycomb fired body 140 are, as shown in FIGS. 2A and 2B, a multitude of cells 141 placed in parallel in the longitudinal direction, and cell walls 143, which partition the cells 141 individually, and provide filtration functionality.

More specifically, as shown in FIG. 2B, the end portion of either the exhaust gas inlet side or the exhaust gas outlet side of the cells 141 formed in the honeycomb fired body 140 is sealed by a plug material layer 142. Therefore, the exhaust gas which enters one cell 141 will always pass through the cell wall 143 dividing the cells 141 to flow out through another one of the cells 141. When the exhaust gas passes through the cell wall 143, particulates contained within the exhaust gas are captured by the cell wall 143, to thereby purify the exhaust gas.

Conventionally, when manufacturing such a honeycomb structured body 130, first a ceramic powder raw material and a binder are combined. Then, a liquid dispersal medium and the like are added and all of the above is mixed together to prepare a wet mixture. Using a die, the wet mixture is continuously extraction molded, and the extruded molded body is then cut to a prescribed length to produce a rectangular pillar-shaped honeycomb molded body.

Next, the honeycomb molded body obtained above is dried using microwave drying or hot air drying. Afterward, either end of prescribed cells are sealed using the plug material layer in order to achieve a sealed state of the cells. After the sealed state has been achieved, degreasing and firing treatment is carried out, thus producing the honeycomb fired body.

Afterward, a sealing material paste is applied onto the side faces of the honeycomb fired body, and the honeycomb fired bodies are adhered together using the sealing material paste. This state of a multitude of the honeycomb fired bodies being combined with one another by interposing an adhesive layer effectuates an aggregate of honeycomb fired bodies. Excision is then carried out on the achieved aggregate of honeycomb fired bodies using a cutting machine or the like to achieve a ceramic block of a prescribed form, such as a cylindrical or cylindroid form or the like. Finally, a sealing material paste is applied on the periphery of the ceramic block to form a coat layer, thereby concluding the manufacture of the honeycomb structured body.

In JP-A 2002-253946 for instance, an apparatus for agitating wet raw material, and supplying it to a molding apparatus is disclosed as an apparatus for mixing raw material powder containing ceramic powder in a method of manufacturing such a honeycomb structured body.

The contents of JP-A 2002-253946 are incorporated herein by reference in their entirety.

### SUMMARY OF THE INVENTION

A method for mixing powder according to the present invention is a method for mixing powder by conducting mixing and transporting of at least one kind of powder, comprising: charging the at least one kind of powder into an agitation apparatus; and translating the at least one kind of powder while mixing the powder by rotating an agitation shaft of the agitation apparatus, the agitation apparatus comprising: a screw comprised of the agitation shaft and an agitating blade, the screw configured to rotate along with the agitation shaft as the center; and, a casing surrounding the screw, wherein either the entire body of the agitating blade is formed of a high hardness member, or, a high hardness coat layer is formed onto at least a portion of the agitating blade.

In the above-mentioned method for mixing powder, it is preferable that the at least one kind of powder includes an inorganic powder and an organic powder. Here, it is also preferable that the inorganic powder is charged into the agitation apparatus in a manner to retain the inorganic powder inside the casing for a period longer than the organic powder.

Also, in the above-mentioned method for mixing powder, it is preferable to further comprises charging the organic powder into the agitation apparatus after charging the inorganic powder comprising two or more kinds of powder of differing particle diameters, in descending order of the particle diameter.

Also, in the above-mentioned method for mixing powder, it is preferable that a main component of the high hardness member and the high hardness coat layer comprises tungsten carbide.

Also, in the above-mentioned method for mixing powder, it is preferable that a distance between an edge portion of the agitating blade and an interior wall face of the casing exceeds 3 mm but is about 10 mm or less.

Also, in the above-mentioned method for mixing powder, it is preferable that the high hardness coat layer is formed on the agitating blade, the high hardness coat layer having a width of at least about 7 mm and at most about 20 mm.

Also, in the above-mentioned method for mixing powder, it is preferable that a surface roughness Ra of the high hardness member or the high hardness coat layer is about 8 μm or less.

In the above-mentioned method for mixing powder, it is preferable that the charging amount of the at least one kind of powder is such that the upper surface of the at least one kind of powder lies at the same position as, or lower than, the lower end of the agitation shaft, when the screw is not in operation.

Further, it is preferable that the charging amount of the at least one kind of powder is such that the upper surface of the at least one kind of powder lies at the position of at least about 10% and at most about 50% of the height of the interior of the casing, when the screw is rotating.

The agitation apparatus according to the present invention is an agitation apparatus, which translates a powder mixture containing at least one kind of powder while mixing the powder mixture, comprising: a screw comprised of an agitation shaft and an agitating blade, the screw rotating along with the agitation shaft as the center; and a casing surrounding the screw, wherein either the entire body of the agitating blade is formed of a high hardness member, or, a high hardness coat layer is formed onto at least a portion of the agitating blade.

In the agitation apparatus according to the present invention, it is preferable that a main component of the high hardness member and the high hardness coat layer comprises tungsten carbide.

Also, in the above-mentioned agitation apparatus, it is preferable that a distance between an edge portion of the agitating blade and an interior wall face of the casing exceeds 3 mm but is about 10 mm or less.

Also, in the above-mentioned agitation apparatus, it is preferable that the diameter of the agitation shaft is at least about 60 mm and at most about 200 mm, the width of the agitating blade is at least about 15 mm and at most about 30 mm, and the agitating blade is disposed substantially perpendicular to the agitation shaft. Further, it is preferable that the agitating blade is wrapped around the agitation shaft in a spiral shape, the space interval between the adjacent windings of the agitation shaft set to at least about 50 mm and at most about 100 mm.

Also, in the above-mentioned agitation apparatus, it is preferable that the high hardness coat layer is formed on the agitating blade, the high hardness coat layer having a width of at least about 7 mm and at most about 20 mm. It is also preferable that the high hardness coat layer is formed by a spraying method.

Also, in the above-mentioned agitation apparatus, it is preferable that a surface roughness Ra of the high hardness member or the high hardness coat layer is about 8 μm or less.

The method for manufacturing honeycomb structured body according to the present invention is a method for manufacturing a honeycomb structured body comprising a honeycomb fired body including: carrying out mixing-transporting process for mixing and transporting a raw material powder containing at least one kind of a ceramic powder; preparing a wet mixture by mixing further a liquid raw material with a mixture of the raw material powder, manufacturing a pillar-shaped honeycomb molded body in which a number of cells are placed in parallel with one another in the longitudinal direction with a cell wall therebetween by molding the wet mixture, manufacturing a honeycomb fired body by firing the honeycomb molded body, the mixing-transporting process comprising: charging the raw material powder into an agitation apparatus; and translating the raw material powder while mixing the powder by rotating an agitation shaft of the agitation apparatus, the agitation apparatus comprising: a screw comprised of the agitation shaft and an agitating blade, the screw configured to rotate along with the agitation shaft as the center; and, a casing surrounding the screw, wherein either the entire body of the agitating blade is formed of a high hardness member, or, a high hardness coat layer is formed onto at least a portion of the agitating blade.

In the present specification, the shape indicated by the word “pillar” refers to any desired shape of a pillar including a round, oval or polygonal pillar and the like.

In the method for manufacturing honeycomb structured body according to the present invention, it is preferable that the raw material powder contains a ceramic powder and an organic powder. Here, the ceramic powder is charged into the agitation apparatus in a manner to retain the ceramic powder inside the casing for a period longer than the organic powder.

In the method for manufacturing honeycomb structured body according to the present invention, it is also preferable to further comprises charging the organic powder into the agitation apparatus after charging the ceramic powder comprising two or more kinds of powder of differing particle diameters, in descending order of the particle diameter.

In the agitation apparatus used in the method for manufacturing according to the present invention, it is preferable that a main component of the high hardness member and the high hardness coat layer comprises tungsten carbide.

Also, in the agitation apparatus used in the method for manufacturing according to the present invention, it is preferable that a distance between an edge portion of the agitating blade and an interior wall face of the casing exceeds 3 mm but is about 10 mm or less.

In the method for manufacturing a honeycomb structured body, it is preferable that the high hardness coat layer is formed on the agitating blade, the high hardness coat layer having a width of at least about 7 mm and at most about 20 mm.

Also, in the agitation apparatus used in the method for manufacturing according to the present invention, it is preferable that a surface roughness Ra of the high hardness member or the high hardness coat layer is about 8 μm or less.

Also, in the above-mentioned method for manufacturing a honeycomb structured body, it is preferable that the charging amount of the raw material powder is such that the upper surface of the raw material powder lies at the same position as, or lower than, the lower end of the agitation shaft, when the screw is not in operation.

It is also preferable that the charging amount of the raw material powder is such that the upper surface of the raw material powder lies at the position of at least about 10% and at most about 50% of the height of the interior of the casing, when the screw is rotating.

### BRIEF DESCRIPTION OF THE DRAWINGS

FIG. 1 is a perspective drawing schematically showing an example of a honeycomb structured body.

FIG. 2A is a perspective view schematically showing the honeycomb fired body constituting the above-mentioned honeycomb structured body. FIG. 2B is a A-A line cross-sectional view of FIG. 2A.

FIG. 3A is a cross section view schematically showing an example of the agitation apparatus according to the present invention. FIG. 3B is a A-A line cross-sectional view of the agitation apparatus shown in FIG. 3A. FIG. 3C is an enlarged cross section view showing a part of the agitation apparatus shown in FIG. 3A.

### DESCRIPTION OF THE EMBODIMENTS

Firstly, description will be described in regard to the method for mixing powder according to the embodiments of the present invention and the agitation apparatus according to the embodiments of the present invention. The method for mixing according to the embodiments of the present invention is a method for mixing powder by conducting mixing and transporting of at least one kind of powder, comprising: charging the at least one kind of powder into an agitation apparatus; and translating the at least one kind of powder while mixing the powder by rotating an agitation shaft of the agitation apparatus, the agitation apparatus comprising: a screw comprised of the agitation shaft and an agitating blade, the screw configured to rotate along with the agitation shaft as the center; and, a casing surrounding the screw, wherein either the entire body of the agitating blade is formed of a high hardness member, or, a high hardness coat layer is formed onto at least a portion of the agitating blade.

Also, the agitation apparatus according to the embodiments of the present invention is an agitation apparatus, which translates a powder mixture containing at least one kind of powder while mixing the powder mixture, comprising: a screw comprised of an agitation shaft and an agitating blade, the screw rotating along with the agitation shaft as the center; and a casing surrounding the screw, wherein either the entire body of the agitating blade is formed of a high hardness member, or, a high hardness coat layer is formed onto at least a portion of the agitating blade.

Therefore, the method for mixing powder according to the embodiments of the present invention may be optimally carried out using the agitation apparatus according to the embodiments of the present invention.

Firstly, description will be put forth in regard to the constitution of the agitation apparatus according to the embodiments of the present invention in reference to the figures.

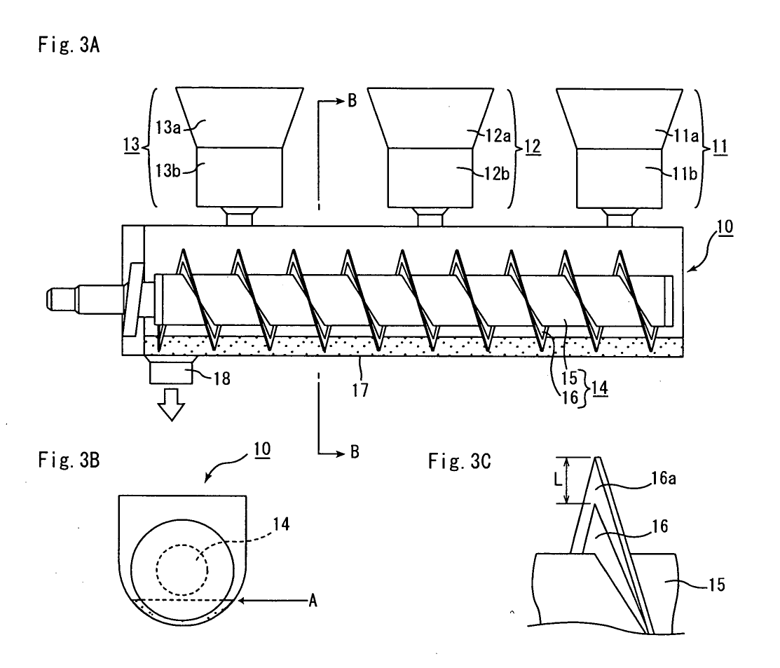

FIG. 3A is a cross section view schematically showing an example of the agitation apparatus according to an embodiment of the present invention. FIG. 3B is a B-B line cross-sectional view of the agitation apparatus shown in FIG. 3A. FIG. 3C is an enlarged cross section view showing a portion of the agitation apparatus shown in FIG. 3A.

This agitation apparatus 10 is chiefly comprised of a coarse grain tank 11, a fine grain tank 12, a binder tank 13, a screw 14, and a casing 17. The coarse grain tank 11 is for the purpose of containing a coarse inorganic powder while the fine grain tank 12 is for the purpose of containing a fine inorganic powder. The binder tank 13 is for the purpose of containing a binder. The screw 14 is comprised of an agitation shaft 15 and an agitating blade 16, and rotates along with the agitation shaft 15 as its center. The casing 17 is disposed surrounding the screw 14. An outlet 18 is formed thereon at a site near the end portion of the casing 17. Moreover, although omitted from the figures, there is engaged thereon an end of the screw 14 a belt. The belt is engaged thereto an end of a motor, in such that the screw 14 will rotate along with the rotation of the motor.

And each tank, specifically, the coarse grain tank 11, the fine grain tank 12, and the binder tank 13, are each constituted by storage portions 11a, 12a, 13a, and measuring charging units 11b, 12b, and 13b.

Also, although not shown in the figures, a separate storage tank is disposed for the purpose of taking in this raw material powder (coarse inorganic powder, fine inorganic powder, and binder) from the outside, and according to air transporting and the like, supplies the required amount of raw material powder to each of the tanks such as the coarse grain tank 11 successively. In the coarse grain tank 11, the fine grain tank 12, and the binder tank 13, the amount raw material that has been accumulated in the storage portions 11a, 12a, and 13a is gauged by the charging amount gauge members 11b, 12b, and 13b, and afterward, a prescribed amount of raw material powder falls into the interior of the casing 17 inside of which the screw 14 is rotating.

Each of the raw material powders that have fallen into the interior of the casing 17 are transported while being mixed according to the agitating blade 16. Here, in a case in which silicon carbide powder is used as one of the raw material powders, because silicon carbide powder is an extremely hard inorganic powder that is also used in polishing agents and the like, there is a concern that the agitating blade 16 itself may suffer wear according to the silicon carbide powder. That is where a sprayed layer having the hard material tungsten carbide as the main component is formed on a portion 16 of about 10 mm from the edge of the agitating blade, as a high hardness coat layer 16a.

Because of this, the agitating blade 16 is highly resistant to wear, and makes it possible to continuously carry out running without replacement of the screw for a long period of time.

On the agitation apparatus according to the embodiments of the present invention, it is preferable that the width of the above-mentioned high hardness coat layer is at least about 7 mm and at most about 20 mm.

With the width of the high hardness coat layer of about 7 mm or more, the contact surface area of the agitating blade with the silicon carbide powder and the like is less likely to increase which prevents the state of wear on the agitating blade from progressing. Alternately, with the width of the above-mentioned high hardness coat layer being about 20 mm or less, the raw material powder is less likely to adhere to the agitating blade, which progresses satisfactory mixing of the raw material powder.

Moreover, in the embodiments of the present invention, the term ‘width of the high hardness coat layer’ refers to the distance (See ‘L’ in FIG. 3C) of the portion on the agitating blade on which the high hardness coat layer is formed from the edge of the agitating blade.

Also, it is preferable that the thickness of the above-mentioned high hardness coat layer have a minimum limit of about 0.10 mm, although an even more preferable minimum limit for thickness is about 0.20 mm. It is preferable that the thickness of the above-mentioned high hardness coat layer have a maximum limit of about 0.60 mm, although an even more preferable maximum limit for thickness is about 0.40 mm. If the object was to merely secure the desirable hardness of the high hardness coat layer set forth hereinafter, then the thickness of the high hardness coat layer would be sufficient if it was about 10 μm or more. However, at a thickness of such an extent, wear resistance remains insufficient, and in order to secure sufficient wear resistance, it is preferable that the thickness of the above-mentioned high hardness coat layer be about 0.10 mm or more. Also, if the above-mentioned thickness of the high hardness coat layer is about 0.4 mm or less, the formation of the high hardness coat layer having a thickness of about 0.4 mm or less will not require high costs, making it economically advantageous.

Thus, it is preferable that the thickness of above-mentioned high hardness coat layer be within above-mentioned range.

Also, in the agitation apparatus 10 shown in FIG. 3A, although the high hardness coat layer is formed onto a portion of the agitating blade comprising the agitation apparatus 10, in the agitation apparatus according to the embodiments of the present invention, it is also acceptable for the high hardness coat layer to be formed over the entirety of the agitating blade, and in some cases, it is also acceptable for the high hardness coat layer to be formed over the entirety of the screw, which is comprised of the agitation shaft and the agitating blade.

Also, it is acceptable for only a portion of, or the entirety of the agitating blade comprising the screw to be constituted by the high hardness member. And in some cases, it is acceptable for the entire screw to be constituted by the high hardness member.

However, in the agitation apparatus according to the above-mentioned embodiments, it is preferable that either the high hardness coat layer be formed on a portion of the above-mentioned agitating blade, or, a portion of the above-mentioned agitating blade be comprised of the high hardness member.

This is because the surface roughness of the above-mentioned high hardness coat layer and the high hardness member normally tend to be greater than the surface roughness of the agitation shaft body and the agitating blade body, and in particular, the high hardness coat layer formed by spraying tends to have a surface roughness greater in comparison to the surface roughness of the agitation apparatus body and the agitating blade body.

If the surface roughness is suppressed to a small value, it becomes difficult for the raw material powder to adhere to the agitation shaft and the agitating blade, and if the raw material powder has difficulty in adhering to the agitating blade, and the like, uniform mixing of the raw material powder may be prevented from being inhibited.

One of the reasons that either the high hardness coat layer preferably be formed on a portion of the above-mentioned agitating blade, or, a portion of the above-mentioned agitating blade preferably be comprised of the high hardness member is that the requiring of cost in cases in which the region occupied by the above-mentioned high hardness coat layer and the high hardness member is great.

Also, it is preferable that the surface roughness of the high hardness coat layer formed on the above-mentioned agitating blade or the high hardness member constituting the above-mentioned agitating blade be about 8 μm or less.

This is because if the above-mentioned surface roughness Ra is about 8 μm or less, there are cases in which the raw material powder may have difficulty in adhering to the agitation shaft to prevent the raw material powder from adhering to the agitation shaft, thereby preventing even mixing of the raw material powder from being inhibited.

Also, it is preferable that the surface roughness Ra of the above-mentioned agitation shaft be about 4 μm or less. This is because if the surface roughness Ra of the above-mentioned agitation shaft is about 4 μm or less, cases in which the raw material powder come to adhere to the agitation shaft tend to occur less frequently; thus, the raw material powder come to adhere to the agitation shaft less frequently, thereby less likely to prevent uniform mixing of the raw material powder from being inhibited.

Also, in cases in which the surface roughness Ra is great on the agitation shaft and the agitating blade, the agitation shaft and the agitating blade tend to be less resistant to wear.

Moreover, in this description according to the present invention, the term ‘surface roughness Ra’ refers to the arithmetic mean roughness based on JIS B 0601.

The contents of JIS B 0601 are incorporated herein by reference in their entirety.

Also, examples of methods to set the surface roughness Ra of the above-mentioned high hardness layer or the high hardness member within the above-mentioned range include methods using buff polishing, grind stones or sheets and the like for instance. Abrasive grain containing buffs such as disk type buffs, flap type buffs, swirl type buffs, as well as abrasive grain-less buffs such as polypropylene fiber-less textile buff for instance are available for use in the above buff polishing. Examples of the grain for use in the above-mentioned abrasive grain containing buff include aluminum silicate, aluminum oxide, silicon carbide and the like, for instance.

Examples of the kinds of the above-mentioned grindstone include resinoid grind stone (resin series), magnesia grind stone (cement series), diamond grind stone, rubber control grind stone, epoxy control grind stone, and the like for instance.

Also, it is possible to use a sheet containing a sheet polishing material having a particle size in the range of #A60 to #A240 for instance as the above-mentioned sheet. More specifically, examples of the above-mentioned sheet include materials such as urethane sponge, nylon fiber-less textile, and acrylic (sponge), that have adhered thereto abrasive granules such as aluminum silicate, aluminum oxide, silicon carbide, and the like for instance.

Moreover, the above-mentioned high hardness coat layer and the high hardness member (herein after both termed ‘high hardness coat layers and the like’) are, in the present invention, of a Vickers Hardness (HV) of 1000 or more as measured based on JIS Z 2244.

Although it is acceptable for the above-mentioned Vickers Hardness (HV) to be at least 1000 (HV), it is more preferable that the Vickers Hardness be 2000 (HV) or more. This will achieve a particularly excellent wear resistance property.

The contents of JIS Z 2244 are incorporated herein by reference in their entirety.

Examples of the above-mentioned high hardness coat layers and the like include ceramic coating material, industrial grade diamond, plating coat film and the like for instance. Examples of the specific materials of the above-mentioned high hardness coat layers and the like include materials having substances such as titanium carbide (HV: 3600), titanium nitride (HV: 1800 to 2500), cubic boron nitride (HV: 2700), CVD diamond (HV: 2500 to 4000), DLC (Diamond-like Carbon/HV: 2000 to 4000), ZrN (HV: 2000 to 2200), CrN (HV: 1800 to 2200), TiCN (HV: 2300 to 3500), TiAlN (HV: 2300 to 3300), Al₂O₃ (HV: 2200 to 2400), Ti3 (HV: 2300), WC— 12% CO (HV: 1200) or the like for instance as the main component, other than the tungsten carbide (HV: 2500). Also, concrete examples of the plating coat film include electroless nickel plating (Treated at approximately 400 Degrees Celsius) (HV: 1000), CrC4 (hard chrome carbide about 4%), plating (HV: 1200), nickel plating (about 2 to about 6% SiC content: Treated at about 400 Degrees Celsius) (HV: 1300 to 1400) and the like.

Moreover, in this description according to the present invention, the Vickers Hardness of each material mentioned in the above parentheses are all approximate values.

Also, out of all of the above-mentioned materials, tungsten carbide is preferable. This is because it becomes easier to form a layer that adheres to the agitating blade body and the like uniformly, strongly, and in a manner tightly adhered thereto, in a case of forming the high hardness coat layers by spraying.

Also, examples of the material for the above-mentioned high hardness member include materials having tungsten carbide, titanium carbide, titanium nitride, ZrN, CrN, TiCN, TiAlN, Al₂O₃, or the like as the main component, for instance.

Examples of the methods of forming the above-mentioned high hardness coat layer includes methods such as spraying, plating, processing of a combination of these, CVD, PVD, UBM, and the like. Out of the above-mentioned methods, spraying and plating are preferable methods, the most preferable method being the spraying method.

This is because while it is possible to form the high hardness coat layer using methods besides the spraying method, such as CVD, PVD, and the like, in a case of doing so, forming a high hardness coat layer of a preferable thickness as mentioned above tends to require a high cost. Another reason is that upon using methods other than the sprayed layer method such as CVD, PVD, etc., it may become easier to apply such methods in cases of formation of the high hardness coat layer onto portions of broad areas as well as portions having complicated contours.

In contrast, in a case of forming the high hardness coat layer using spraying, it becomes easier to form the coating having a desired thickness in a short period of time and at a low cost. Also, with the spraying method, it is possible to form the high hardness coat layer onto even large components in one run at in a short period of time.

Moreover, although it is difficult to form the layer onto large components using methods such as CVD, PVD, UBM and the like, by employing a method of dividing the large component into small components and forming the high hardness coat layer thereto, then reassembling the small components into the large component afterward, the methods such as CVD, PVD, UBM may be employed to manufacture the screw as well.

More specifically, it is possible to use frame spraying, high speed frame spraying, burst spraying, arc spraying, plasma spraying, arc ion coating (AIP), hollow cathode ion coating (HCD), and the like as the above-mentioned spraying method.

And in regard to the above-mentioned high hardness coat layers and the like, the material set forth above is used as the main component, and it is also possible to contain metallic components such as Co, Cr, Ni, and the like as other components therein.

Moreover, although plasma spray coated Cr₂O₅ (HV: 600), rhodium plating (HV: 800 to 1000), Cr plating (hard chrome) (HV: 700), electroless nickel plating (HV: 660) and the like are known for their use as metallic layers, the Vickers Hardness of these metallic coat layers is a small value of less than about HV 1000, and are therefore have low resistance to wear. It is preferable to use a metallic coat layer of the sort set forth herein above having a Vickers Hardness of about HV 1000 or more.

Also, examples of the material of the agitation shaft body or agitating blade body in a case of forming the high hardness coat layer, or the agitating blade or agitation shaft comprised of something other than the high hardness member include stainless steel, nitride steel, carbonic steel and super hard alloys for instance.

In the above-mentioned agitation apparatus, it is preferable that the diameter of the agitation shaft is at least about 60 mm and at most about 200 mm, and the width of the above-mentioned agitating blade is at least about 15 mm and at most about 30 mm.

Also, it is most preferable that the above-mentioned agitating blade be disposed substantially perpendicular to the above-mentioned agitation shaft. And although the agitating blade is disposed in a manner wrapped around the agitation shaft in a spiral shape, it is most preferable that the space interval in between the adjacent windings of the agitation shaft be set to at least about 50 mm and at most about 100 mm. Stated more simply, it is preferable that the above-mentioned agitating blade be established in a spiral shape at a constant space interval of at least about 50 mm and at most about 100 mm.

Also, it is preferable that the distance in between the edge portion of the above-mentioned agitating blade and the interior wall face of the above-mentioned casing exceed 3 mm but is about 10 mm or less.

This is because, with the distance in between the edge portion of the above-mentioned agitating blade and the interior wall face of the above-mentioned casing exceeding 3 mm, the raw material powder may easily be mixed uniformly. On the other hand, with the distance in between the edge portion of the above-mentioned agitating blade and the interior wall face of the above-mentioned casing being about 10 mm or less, smooth transporting of the raw material powder tends not to becomes difficult, which may prevent variance in the transporting amount from generating.

Also, it is preferable that the screw conveyer processing amount be normally at least about 100 Kg/hr and at most about 600 Kg/hr, although this is not particularly limited.

In the agitation apparatus according to the above-mentioned embodiments, in a case including a plurality of tanks (coarse grain tank 11, fine grain tank 12, and binder tank 13 shown in FIG. 3A) for the purpose of supplying the raw material powder, it is preferable that the distance in between each tank is at least about 50 cm and at most about 200 cm.

This is because if the distance in between each tank is about 50 cm or more, there may be cases in which it becomes easier to achieve powder homogenization or uniform mixing of the powders. In contrast, if the tanks are distanced by about 200 cm or less, the powder will be homogenous and the powders will more easily be uniformly mixed. Further distancing of more than about 200 cm will not see any further changes in the state of mixing therein; therefore, the desirable upper limit of the distance in between each tank is presumably about 200 cm.

Also, in the agitation apparatus according to the embodiment shown in FIG. 3A, although there is one kind of tank provided for each raw material powder, in the agitation apparatus according to the embodiments of the present invention, it is also acceptable to provide a plurality of tanks for each raw material powder.

More specifically, it would be acceptable for instance to provide coarse granule tanks at two locations, fine granule tanks at two locations, and binder tanks at two locations.

This kind of agitation apparatus according to the embodiments of the present invention uses the agitating blade having formed thereon the high hardness coat layer, and is therefore highly resistant to wear, making it may become possible to continuously carry out running without replacement of the screw for a long period of time (about 6 months or more for instance).

The method for mixing powder according to the embodiments of the present invention can be executed using the agitation apparatus according to the embodiments described above.

In the method for mixing powder according to the embodiments of the present invention, firstly, at least one kind of powder intended for mixing is charged into the interior of the agitation apparatus. At this point, description will be put forth in regard to a case executing the mixing of two kinds of inorganic powder of differing mean particle diameters and one kind of organic binder, as the above-mentioned at least one kind of powder.

In this case, an inorganic powder of a relatively large mean particle diameter is charged into the coarse grain tank 11, an inorganic powder of a relatively small mean particle diameter is charged into the fine grain tank 12, and the organic binder (organic powder) is charged into the binder tank 13, respectively. Then, after opening the outlet of each tank, each of the powders is charged onto the interior of the casing 17.

Here, each of the tanks in the agitation apparatus 10 are installed in a manner as to be positioned at a spot far from an outlet 18 in the order of the coarse grain tank 11, the fine grain tank 12 and the binder tank 13.

The reason for this is that in a case of mixing the inorganic powder and the organic powder together, if charging is carried out in a manner to retain the inorganic powder inside of the casing for a period longer than organic binder, mixing at an even greater degree of uniformity can easily be achieved.

Also, it is because in a case of the two kinds of inorganic powders of differing mean particle diameters as well, carrying out charging in a manner to retain the inorganic powder of the greater mean particle diameter inside of the casing longer than others will easily also achieve mixing at an even greater degree of uniformity.

Moreover, at this point, although description has been set forth in regard to a case in which two kinds of inorganic powder and one kind of organic binder are mixed, in cases in which two or more kinds of organic binder having differing mean particle diameters for example are mixed as well, carrying out charging in a manner to retain the one of the greater mean particle diameter longer inside of the casing than others is preferable.

Also, in a case in which a plurality of inorganic powders having almost identical mean particle diameters are mixed for instance, carrying out charging in a manner to retain the one of the greater bulk density longer inside of the casing than others is preferable. The above also applies in regard to cases of the organic particles as well.

In the method for mixing powder according to the embodiments of the present invention, it is preferable that the rotational speed of the screw 14 is at least about 20 min⁻¹ and at most about 200 min⁻¹ (rpm).

This is because, with a rotational speed of about 20 min⁻¹ or more, the transporting speed of the mixed powder tends to have difficulty in becoming excessively slow so that productivity is prevented from becoming low, and with a rotational speed of about 200 min⁻¹ or less, sufficient mixing tends to be carried out easily.

Also, it is preferable that the amount of the raw material powder (the above-mentioned at least one kind of powder) is such that the upper surface (Refer to ‘A’ in FIG. 3B) of the raw material powder lies below substantially the half point of the diameter of the agitation shaft 15, when the screw 14 is stopped.

This is because unsatisfactory mixing is easy to occur in cases in which the amount of the raw material powder has come to the point that the upper surface of the raw material powder is above substantially the half point of the diameter of the agitation shaft 15.

Moreover, it is even more preferable that the amount of the raw material powder is such that the upper surface of the raw material powder lies at the same position as, or lower than, the lower end of the agitation shaft 15, when the screw 14 is not in operation. This is because not only does this tend to promote satisfactory mixing, but tends to allow transporting to proceed more smoothly. Another reason is that because the surface area of contact with the agitating blade is small, there is high resistance to wear, making it possible to even further reduce the frequency at which the agitating blade must be exchanged, more easily.

It is also preferable that the amount of the raw material powder is such that the upper surface of the raw material powder lies at the position of at least about 10% and at most about 50% of the height of the interior of the casing, when the screw 14 is in operation.

This is because if the upper surface of the raw material powder lies at the position of about 10% or more of the height of the interior of the casing, the degree of mixing will be prevented from becoming insufficient, and cases in which the amount transporting will be small tends to be prevented from occurring. And if the upper surface of the raw material powder lies at the position of about 50% or less of the height of the interior of the casing, the raw material powder tends to easily be prevented from reaching the top portion of the screw along with rotation of the screw which will prevent the agitating blade from wearing, and also prevent the wear to extend to the agitation shaft, more easily.

In this sort of method for mixing powder according to the embodiments of the present invention, alongside being able to more easily conduct mixing of powder in a uniform manner, because an embodiment in which the agitation apparatus having the high hardness coat layer formed onto the agitating blade is used, the agitating blade is highly resistant to wear, which makes it possible to continuously carry out running without replacement of the screw for a long period of time. And it may become possible thereby, to more easily prevent decreases in operation efficiency and productivity that may have arisen due to the halting of running, while also preventing rises in equipment expenses.

Next, description will be described with regard to the honeycomb structured body manufacturing method according to the embodiments of the present invention.

The method for manufacturing honeycomb structured body according to the embodiments of the present invention is a method for manufacturing a honeycomb structured body comprising a honeycomb fired body including the following steps of: carrying out mixing-transporting process for mixing and transporting a raw material powder containing at least one kind of a ceramic powder; preparing a wet mixture by mixing further a liquid raw material with a mixture of the raw material powder, manufacturing a pillar shaped honeycomb molded body in which a number of cells are placed in parallel with one another in the longitudinal direction with a cell wall therebetween by molding the wet mixture, manufacturing a honeycomb fired body by firing the honeycomb molded body, the mixing-transporting process comprising: charging the raw material powder into an agitation apparatus; and translating the raw material powder while mixing the powder by rotating an agitation shaft of the agitation apparatus, the agitation apparatus comprising: a screw comprised of the agitation shaft and an agitating blade, the screw configured to rotate along with the agitation shaft as the center; and, a casing surrounding the screw, wherein either the entire body of the agitating blade is formed of a high hardness member, or, a high hardness coat layer is formed onto at least a portion of the agitating blade.

That is, the method for manufacturing a honeycomb structured body according to the embodiments of the present invention uses the agitation apparatus and a method for mixing powder according to the embodiments of the present invention as described above in the mixing-transporting process of the raw material powder.

Herein below, description will be put forth in regard to the process order of the honeycomb structured body manufacturing method according to the embodiments of the present invention.

At this point, description will be put forth in regard to the honeycomb structured body manufacturing method using silicon carbide powder as the inorganic powder, using a case of manufacturing a honeycomb structured body having silicon carbide as the main component of the constitution material as an example.

Of course the main component of the constitution material of the honeycomb structured body is not limited to silicon carbide, as other examples of main component of the constitution material of the honeycomb structured body include components such as nitride ceramics such as aluminum nitride, silicon nitride, boron nitride, titanium nitride; carbide ceramics such as zirconium carbide, titanium carbide, tantalum carbide, tungsten carbide; and oxide ceramics such as alumina, zirconia, cordierite, mullite, and aluminum titanate, and the like for instance.

Out of the above-mentioned possible components, non-oxide ceramics are desirable for use as the main component of the constituting material of the honeycomb structured body, with silicon carbide being particularly desirable. This is because non oxide ceramics and silicon carbide are excellent in thermal resistance properties, mechanical strength, and thermal conductivity. Moreover, silicon-containing ceramic, in which metallic silicon is blended with the ceramics set forth above, as well as ceramic bound by silicon or silicate compounds can also be used as the constituting material of the honeycomb structured body. And out of these, those ceramics (silicon-containing silicon carbide) in which metallic silicon is blended with silicon carbide are preferably used.

(1) Firstly, organic binder (organic powder) and silicon carbide powder differing in mean particle diameters are dry mixed to prepare a powder mixture.

In the manufacturing method according to the embodiments of the present invention, in this process the previously described method for mixing powder according to the embodiments of the present invention is used.

Here, the prepared powder mixture is educted from the outlet (outlet 18 in FIG. 3A) of the agitation apparatus and charged in the next process.

The particle diameter of the above-mentioned silicon carbide powder is not particularly limited, preferably the silicon carbide powder has a less degree of constraction in the subsequent firing process. A powder having a combination of 100 parts weight of powder having a mean particle diameter of at least about 0.3 μm and at most about 50 μm, and at least about 5 parts by weight and at most about 65 parts by weight of powder having a mean particle diameter of at least about 0.1 μm and at most about 1.0 μm is preferable.

In order to adjust the pore diameter and the like of the honeycomb fired body, it is necessary to adjust the firing temperature. However it also becomes more easier to adjust the pore diameter by adjusting the particle diameter of the inorganic powder.

Then the powder having a mean particle diameter of at least about 0.3 μm and at most about 50 μm is charged into the tank (coarse grain tank 11 in FIG. 3A) that is positioned farthest from the outlet of the agitation apparatus, and the powder having a mean particle diameter of at least about 0.1 μm and at most about 1.0 μm is charged into the tank (coarse grain tank 12 in FIG. 3A) that is positioned second farthest from the outlet of the agitation apparatus.

The above-mentioned organic binder is not particularly limited, and examples of the above-mentioned organic binder include methyl cellulose, carboxymethyl cellulose, hydroxyethyl cellulose, polyethylene glycol and the like for instance. Out of the above, methyl cellulose is preferable for use. It is preferable that the blending amount of the above-mentioned binder normally be at least about 1 part by weight and at most about 10 parts by weight to each 100 parts weight of the inorganic powder.

Moreover, the organic binder is charged into the tank (the binder tank 13 in FIG. 3A) that is positioned nearest from the outlet of the agitation apparatus.

(2) Next, a liquid mixture is prepared by mixing a liquid plasticizer, a lubricant agent and water, and then using a wet mixing apparatus the above-mentioned liquid mixture and the powder mixture prepared in the above-mentioned (1) process are mixed together, thereby preparing a wet mixture for use in the manufacture of the molded body.

The above-mentioned plasticizer is not particularly limited, as examples of the above-mentioned plasticizer include glycerin and the like for instance.

The above-mentioned lubricant agent is also not particularly limited, as examples of the above-mentioned lubricant agent include polyoxyalkylene series compounds such as polyoxyethylene alkyl ether, polyoxypropylene alkyl ether, and the like for instance.

More concrete examples of the lubricant agent include polyoxyethylene monobutyl ether, polyoxypropylene monobutyl ether, and the like for instance.

Moreover, in some cases it is acceptable if the wet mixture does not contain the plasticizer or the lubricant agent.

And when preparing the above-mentioned wet mixture, it is also acceptable to use a dispersant. And examples of the above-mentioned dispersal liquid include water, organic solvents such as benzene and the like, or alcohols such as methanol and the like, for instance.

Moreover, it is acceptable to add a molding auxiliary to the above-mentioned wet mixture. The above-mentioned molding auxiliary is not particularly limited, as examples of the above-mentioned molding aid include ethylene glycol, dextrin, fatty acid, fatty acid soap, polyalcohol and the like, for instance.

Moreover, according to need it is acceptable to add a pore-forming agents such as a balloon (which is made of micro-sized hollow spherical bodies containing oxide ceramic as ingredient), a spherical acrylic particle and graphite, and the like to the above-mentioned wet mixture.

The above-mentioned balloon is not particularly limited, as examples of the above-mentioned balloon include alumina balloon, glass micro balloon, shirasu balloon, fly ash balloon (FA balloon), mullite balloon and the like, for instance. Out of these, alumina balloon is preferable for use.

The wet mixture using the silicon carbide powder prepared here is preferably at a temperature of about 28 Degrees Celsius or below. This is because the organic binder will undergo gelatinization at excessively high temperature.

Also it is preferable that the proportion of the organic component within the above-mentioned wet mixture be at about 10% by weight or less, and it is preferable that the moisture content be at least about 10% and at most about 17% by weight or less.

(3) After being prepared, the above-mentioned wet mixture is fed to the extraction molding apparatus with a feeding apparatus, where it undergoes extraction molding to manufacture the honeycomb molded body of a desired shape.

Next, the honeycomb molded body is dried using a microwave drying apparatus, a hot air drying apparatus, a dielectric drying apparatus, a reduced pressure drying apparatus, a vacuum drying apparatus, a freeze drying apparatus, or the like, to manufacture a ceramic dry body.

Then, according to need, a prescribed amount of plug material paste which will serve as plugs is injected into the end portion of the outlet side of the group of inlet cells, as well as the end portion of the inlet side of the group of outlet cells, thereby plugging the cells.

Although above-mentioned plug material paste is not particularly limited, one which the porosity of the plug material manufactured in the subsequent processes is at least about 30% and at most about 75% is preferable, and it is for instance, possible to use a substance identical to the above-mentioned wet mixture as the plug material paste.

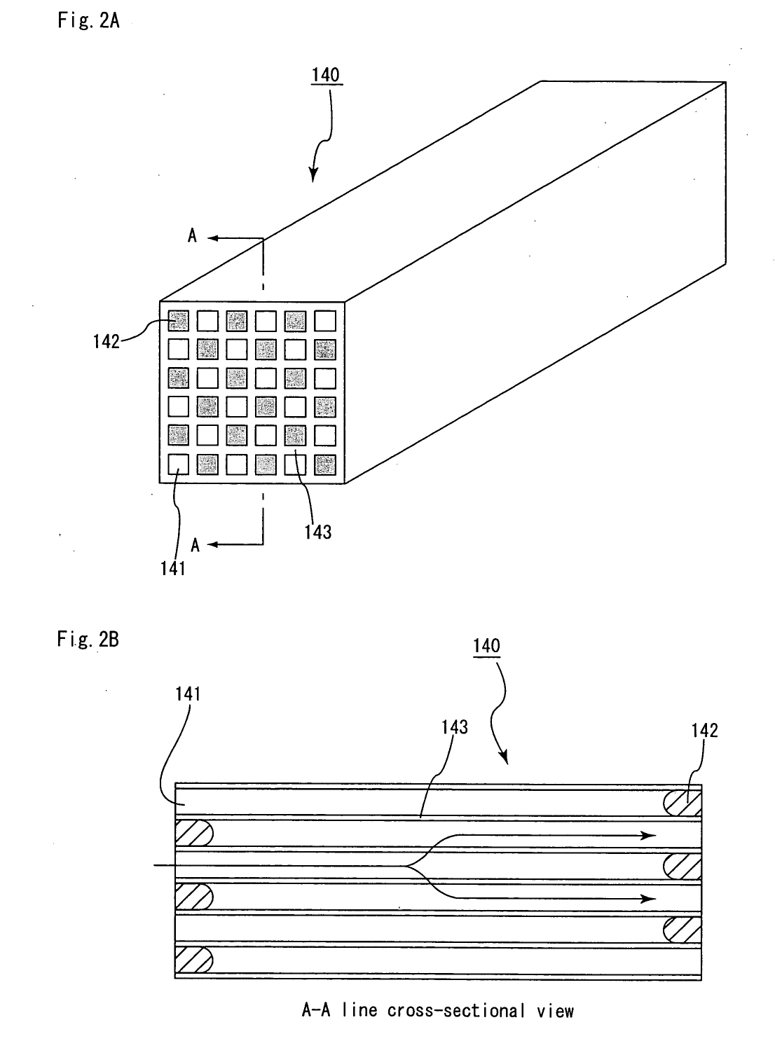

(4) Next, by degreasing (at least about 200 Degrees Celsius and at most about 500 Degrees Celsius for instance) and firing (at least about 1400 Degrees Celsius and at most about 2300 Degrees Celsius for instance) the ceramic dry body plugged with the above-mentioned plug material paste under prescribed conditions, it is possible to manufacture a honeycomb fired body (refer to FIG. 2B) wherein the entire body of which is constituted from a single sintered body, and is comprised of a honeycomb unit in which a number of cells are placed in parallel with one another in the longitudinal direction with a cell wall therebetween, wherein either end portion of the above-mentioned cells is plugged.

In regard to the conditions for degreasing and firing the above-mentioned ceramic dry body, it may become possible to apply conventionally conditions used upon manufacturing a filter comprised of porous ceramic.

(5) Next, the sealing material paste which will serve as the seal layer (the adhesive layer) is coated onto the side of the honeycomb fired body at a uniform thickness to form the sealing material paste layer. On top of this sealing material paste layer, the process of successively piling up other honeycomb fired bodies is carried out repeatedly, thereby manufacturing an aggregate of honeycomb fired body of a prescribed size.

An example of the above-mentioned sealing material paste includes a material comprised of an inorganic binder, an organic binder and, at least one of an inorganic fiber and an inorganic particle, for instance.

Examples of the above-mentioned inorganic binder include silica sol, alumina sol or the like, for instance. It is also acceptable to use the above alone or in combination. Out of the above-mentioned inorganic binders, silica sol is preferable for use.

Examples of the above-mentioned organic binder include polyvinyl alcohol, methyl cellulose, ethyl cellulose, carboxymethyl cellulose and the like, for instance. It is also acceptable to use the above alone or in combination. Out of the above-mentioned organic binders, carboxymethyl cellulose is the most preferable for use.

Examples of the above-mentioned inorganic fiber include a ceramic fiber or the like such as silica-alumina, mullite, alumina, and silica for instance. It is also acceptable to use the above alone or in combination. Out of the above-mentioned inorganic fibers, alumina fiber is preferable for use.

Examples of the above-mentioned inorganic particle include carbide, nitride and or the like, for instance. More concrete examples include inorganic powders comprised of silicon carbide, silicon nitride, or boron nitride. It is also acceptable to use the above alone or in combination. Out of the above-mentioned inorganic particle, silicon carbide, being excellent in thermal conductivity properties, is preferable for use.

Moreover, it is acceptable to add optionally a pore-forming agents such as a balloon (which is made of micro-sized hollow spherical bodies containing an oxide ceramic as ingredient), a spherical acrylic particle, a graphite and the like to the above-mentioned sealing material paste.

The above-mentioned balloon is not particularly limited, as examples of above-mentioned balloon include alumina balloon, glass micro balloon, shirasu balloon, fly ash balloon (FA balloon), mullite balloon and the like, for instance. Out of these, alumina balloon is most preferable for use.

(6) Next, this aggregate of honeycomb fired bodies is heated to dry and solidify the sealing material paste layer, thereby forming the sealing material layer (the adhesive layer) Next, using a diamond cutter or the like, a cutting process is carried out on the aggregate of the honeycomb fired bodies in which a plural of honeycomb fired bodies are combined with one another by interposing the sealing material layer (the adhesive layer), thereby manufacturing a cylindrical shaped ceramic block.

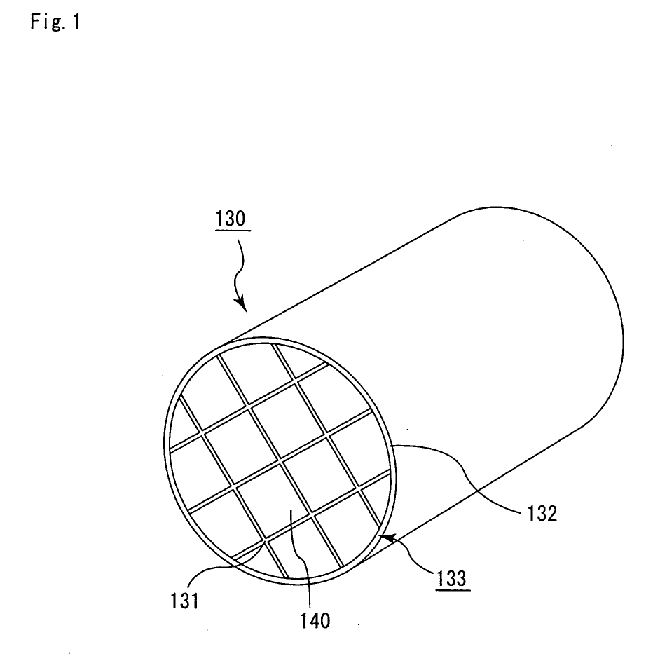

Then using the above-mentioned sealing material paste a coat layer is formed onto the outer periphery of the honeycomb block. By conducting such a process, it is possible to manufacture a honeycomb structured body (Refer to FIG. 1) in which the sealing material layer (coat layer) is formed on the peripheral portion of the cylindrical ceramic block which has a plurality of the honeycomb fired bodies combined with one another by interposing the sealing material layer (adhesive layer).

In the honeycomb structured body manufacturing method according to the embodiments of the present invention, it is also acceptable to support a catalyst on the honeycomb structured body according to necessity.

The supporting of the above-mentioned catalyst can be carried out on the honeycomb fired body before the manufacture of the aggregate body.

In a case of supporting the catalyst, it is preferable to form an alumina coat of a high specific surface area onto the surface of the honeycomb structured body, and then administer a co-catalyst or a catalyst such as platinum or the like onto the surface of this alumina coat.

Examples of methods for forming the alumina coat onto the surface of the above-mentioned honeycomb structured body include methods such as a method of impregnating the honeycomb structured body with a solution of a metallic compound containing an aluminum such as Al₃(NO₃) and then heating, a method of impregnating the honeycomb structured body with a solution containing an aluminum powder and then heating, and the like, for instance.

Examples of method for administering the co-catalyst to the above-mentioned alumina coat include method such as impregnating the honeycomb structured body with a metallic compound solution containing rare earth elements or the like such as Ce(NO₃)₃, and then heating and the like, for instance.

Examples of methods for administering the catalyst to the above-mentioned alumina coat include methods such as impregnating the honeycomb structured body with a nitric acid solution of diammine dinitro platinum ([Pt(NH₃)₂(NO₂)₂]HNO₃, platinum concentration: about 4.53% by weight) and the like, and then heating and the like, for instance.

It is also acceptable to administer the catalyst according to a method of administering a catalyst to alumina particle in advance, and impregnating the honeycomb structured body with a solution containing the alumina powder that has been given the catalyst, and then heating, and the like.

Also, although the honeycomb structured body manufactured by the above-mentioned embodiments of the method for manufacturing a honeycomb structured body described up to this point is a honeycomb structured body having a constitution that a plurality of honeycomb fired bodies are combined with one another by interposing a seal material layer (adhesive layer) (herein after termed ‘aggregated honeycomb structured body’), the honeycomb structured body manufactured by the method for manufacturing according to the embodiments of the present invention can also be a honeycomb structured body in which a cylindrical ceramic block is constituted by a single honeycomb fired body (herein after termed ‘integral honeycomb structured body’).

In a case of the embodiment for manufacturing the integral honeycomb structured body of this sort, the honeycomb molded body is manufactured using the same methods used in the embodiment for the manufacture of the aggregated honeycomb structured body, provided that the size of the honeycomb molded body molded by extrusion molding is larger in comparison to the size of in a case of the embodiment for manufacturing the aggregated honeycomb structured body.

Here, because the embodiments for the method for mixing the raw material powders and the like are identical to those used in the embodiments for the manufacturing method of the above-mentioned aggregated honeycomb structured body, description in regard to the same will be omitted here.

Next, in the same manner as in the embodiments for the manufacture of the aggregated honeycomb structured body, the honeycomb molded body is dried using a microwave drying apparatus, a hot air drying apparatus, a dielectric drying apparatus, a reduced pressure drying apparatus, a vacuum drying apparatus, a freeze drying apparatus, or the like, where it is made into a ceramic dry body. Then, a prescribed amount of the plug material paste which will serve as the plugs is injected to the end portion of the outlet side of the group of inlet cells, as well as the end portion of the inlet side of the group of outlet cells, thereby plugging the cells.

Afterward, in the same manner as in the embodiments for the manufacture of the aggregated honeycomb structured body, a ceramic block is manufactured by degreasing, firing, and forming the sealing material layer (the coat layer) according to necessity, it is possible to manufacture the integral honeycomb structured body. It is also possible to support a catalyst using the methods set forth herein above, in the integral honeycomb structured body according to the above-mentioned embodiments.

Moreover, when the honeycomb structured body is manufactured according to the embodiments for a method of manufacturing the sort set forth herein above, especially in a case of manufacturing the aggregated honeycomb structured body, it is preferable to use two kinds of silicon carbide powders of differing mean particle diameters, or, silicon powder and silicon carbide powder as the inorganic powder; and in a case of the embodiments for manufacturing the integral honeycomb structured body it is preferable to use cordierite raw material powder, or, aluminum titanate powder as the inorganic powder.

Moreover, although the particle diameter that is preferable in a case of blending the silicon carbide powder with the organic binder is as has been set forth herein above, in a case of using silicon powder and silicon carbide powder as the inorganic powder for instance, it is preferable to blend silicon powder having a mean particle diameter of at least about 0.1 μm and at most about 10 μm, and silicon carbide powder having a mean particle diameter of at least about 5 μm and at most about 50 μm, with organic binder.

Also, in a case of using a cordierite raw material powder, it is preferable to blend a talc powder having a mean particle diameter of at least about 5 μm and at most about 60 μm, a kaolin powder having a mean particle diameter of at least about 1 μm and at most about 15 μm, an alumina powder having a mean particle diameter of at least about 0.5 μm and at most about 15 μm, a hydroxide aluminum powder having a mean particle diameter of at least about 0.5 μm and at most about 10 μm, a silica powder having a mean particle diameter of at least about 1 μm and at most about 100 μm, a graphite powder having a mean particle diameter of at least about 1 μm and at most about 15 μm, molding auxiliary, and a dispersant.

And in a case of using aluminum titanate powder, it is preferable to blend a powder having a mean particle diameter of at least about 5 μm and at most about 50 μm, and a powder having a mean particle diameter of at least about 0.1 μm and at most about 15 μm.

In the method for manufacturing honeycomb structured body according to the embodiments of the present invention, having been set forth herein above, because mixing of the raw material powder is conducted using the agitation apparatus having formed thereon the agitating blade the high hardness coat layer, the agitating blade, which constitutes the agitation apparatus, is highly resistant to wear. Therefore, it is possible to continuously carry out running without replacement of the screw for a long period of time, which in turn makes it easier to prevent decreases in operation efficiency and productivity according to halting of running, while also more easily preventing rises in equipment expenses.

The description in the above mainly discuss the method for manufacturing a honeycomb structured body according to the embodiments of the present invention, by taking a honeycomb structured body which can be suitably used as a ceramic filter as an example. However, in the method for manufacturing a honeycomb structured body according to the embodiments of the present invention, the honeycomb structured body may be manufactured without being filled with a plug material paste as mentioned above, and the honeycomb structured body in which the end portion of the cells is not sealed with the plug may be suitably used as a catalyst supporting carrier to exert the same effects as the present invention in which the honeycomb structured body is used as a ceramic filter.

### EXAMPLES

The following description will discuss the present invention in detail by means of examples; however, it is not intended that the present invention be not limited to these examples.

### Example 1

(1) α type silicon carbide powder having a mean particle diameter of 10 μm, α type silicon carbide powder having a mean particle diameter of 0.5 μm, methyl cellulose (organic binder) were mixed together using the agitation apparatus 10 (Refer to FIG. 3A).

More specifically, the above were charged into the interior of the casing, the a type silicon carbide powder having a mean particle diameter of 10 μm charged from the coarse grain tank 11 at an charging speed of 1.8 kg/min, a type silicon carbide powder having a mean particle diameter of 0.5 μm charged from the fine grain tank 12 at an charging speed of 0.7 kg/min, and the methyl cellulose charged from the binder tank 13 at an charging speed of 0.14 kg/min, the screw was driven at a rotational speed of 140 min⁻¹ (rpm) to transport the raw material powder toward the outlet 18 while mixing the raw material powder.

The agitation apparatus 10 used here has included the coarse grain tank 11, the fine grain tank 12, the binder tank 13, the screw 14 which was comprised of the agitation shaft 15 and the agitating blade 16, and the casing 17. The distance between each of the tanks the coarse grain tank 11, the fine grain tank 12, and the binder tank 13 was 100 cm. The diameter of the agitation shaft 15 was 100 mm, and the agitating blade 16, having a width of 25 mm, was disposed perpendicularly to the agitation shaft 15 and was spirally wrapped around the agitation shaft 15 at a space interval of 80 mm in between each winding of the adjacent agitating blade 16. There was a tungsten carbide sprayed layer formed on the agitating blade 16 to a portion of 10 mm from the edge portion of the agitating blade 16 at a thickness of 0.30 mm as the high hardness coat layer 16a. Also, the distance between the edge portion of the agitating blade 1 6 and the interior wall face of the casing was 5 mm. Also, buff polishing had been carried out on the surface of the agitating blade 16 to achieve a surface roughness Ra of 8 μm for the portion of the high hardness coat layer 16a. Buff polishing had also been carried out on the surface of the agitation shaft 15 to achieve a surface roughness Ra of 4 μm.

Also, in the present process, the upper surface of the raw material powder was at a position of 40% of the height of the interior of the casing 17 when the screw 14 was rotating. Also, as a result of observing whether or not the raw material powder got to the opposite side over the agitation shaft at the time of the mixing and transporting, the raw material powder which had gotten over the agitation shaft was not observed.

(2) Separately, 12 kg of a lubricant agent (UNILUB manufactured by the NOF Corp.), 5.6 kg of a plasticizer (glycerin) and 65 kg of water was mixed together to prepare a liquid mixture.

Next, 5.9 kg of the above-mentioned liquid mixture and 26.4 kg of the powder mixture prepared using the agitation apparatus 10 were mixed together using a wet mixing apparatus to prepare a wet mixture.

(3) Next, this wet mixture was then fed to an extraction molding apparatus, and a honeycomb molded body was manufactured by extraction molding. Afterward, the above-mentioned molded body was dried using a microwave drying apparatus and the like, thereby achieving a honeycomb dry body. Afterward, prescribed cells were plugged with a plug material paste having the same composition as the above-mentioned wet mixture.

Next, after further drying the honeycomb dry body using a drying apparatus again, it was degreased at 400 Degrees Celsius and then fired for 3 hours at 2200 Degrees Celsius in an argon atmosphere at atmospheric pressure to manufacture a honeycomb fired body comprised of a silicon carbide sintered body having a porosity of 40%, a mean pore diameter of 12.5 μm, a size of 34.3 mm×34.3 mm×150 mm, the number of cell (cell density) of 46.5 cells/cm², and a cell wall thickness of 0.20 mm.

### Examples 2 to 4, Reference Examples 1 to 3

In the (1) process of Example 1, except that the amount of charging per unit of time of the raw material powder charged from the coarse grain tank 11, the fine grain tank 12, and the binder tank 13 into the agitation apparatus 10 was changed as shown in Table 1-1, the honeycomb fired body was manufactured in a manner identical to Example 1. Also, whether or not the raw material powder had get to the opposite side over the agitation shaft during the mixing and transporting was observed.

(Evaluation of the Agitation Apparatus)

With the following method, a quantitative eduction test was conducted for the agitation apparatus used in Examples 1 to 4 and Reference Examples 1 to 3 to evaluate the variation in the amount of eduction.

Specifically, the weight of the mixture educted from the outlet of the agitation apparatus in a 30 second time period was measured, this measurement process was repeated 10 times, and the variation (standard deviationσ) in the amount of eduction for the 10 times was calculated.

The results of the evaluation are shown in Table 1-1.

Moreover, in this quantitative eduction testing, the less the variation in the eduction amount, the higher degree of uniformity at which the raw material powder will be mixed and transported.

(Strength Measurement of the Honeycomb Fired Body)

With the following method, a three-point bending strength test was conducted for the honeycomb fired body attained in Examples 1 to 4 and Reference Examples 1 to 3.

Specifically, using JIS R 1601 as a reference, Instron 5582 was used to conduct the three-point bending test with a span distance of 135 mm, and at a speed of 1 mm/min, to measure the bending strength (MPa) of each honeycomb fired body.

The results are shown in Table 1-2.

The contents of JIS R 1601 are incorporated herein by reference in its entirety.

(Continuous Running of the Agitation Apparatus)

Manufacture of the honeycomb fired body according to Examples 1 to 4 and Reference Examples 1 to 3 was conducted continuously for a period of 1 month. The degree of wear of the agitation shaft and the agitating blade after the continuous running was then measured by visual observation. Moreover, the degree of wear was measured at the portions suffering the most wear in each the agitation shaft and the agitating blade.

The results are shown in Table 1-2.

Moreover, the quantitative eduction test and the three-point bending strength test were also conducted after continuous running for a period of 1 month under the manufacturing method according to Example 1. The results are shown in Tables 3-1 and 3-2.

TABLE 1-1

| | | | | | Distance between | Variation in the |
|---|---|---|---|---|---|---|
| | Course | | | Raw-Material | Agitation Blade and | Quantitative |
| | Powder | Fine Powder | Binder | Powder Height | casing | Eduction Test |
| | (kg/min) | (kg/min) | (kg/min) | (%) | (mm) | (σ) |
| Example 1 | 1.80 | 0.70 | 0.14 | 40 | 5 | 12.6 |
| Example 2 | 0.77 | 0.30 | 0.06 | 20 | 5 | 17.2 |
| Example 3 | 0.28 | 0.11 | 0.02 | 10 | 5 | 17.7 |
| Example 4 | 2.12 | 0.82 | 0.16 | 50 | 5 | 13.5 |
| Reference | 2.44 | 0.95 | 0.19 | 60 | 5 | 17.7 |
| Example 1 | | | | | | |
| Reference | 3.09 | 1.20 | 0.24 | 70 | 5 | 17.9 |
| Example 2 | | | | | | |
| Reference | 0.19 | 0.07 | 0.01 | 8 | 5 | 20.8 |
| Example 3 | | | | | | |

TABLE 1-2

| | Raw material | | |
|---|---|---|---|
| | powder having | | three-Point |
| | got over the | | Bending |
| | Agitation | Wear after continuous | Strength |
| | Shaft? | running | (MPa) |
| Example 1 | No | Blade <5 mm, Shaft <5 mm | 5.5 |
| Example 2 | No | Blade <5 mm, Shaft <5 mm | 4.9 |
| Example 3 | No | Blade <5 mm, Shaft <5 mm | 4.9 |
| Example 4 | No | Blade <5 mm, Shaft <5 mm | 5.4 |
| Reference | Yes | Blade <5 mm, Shaft 5 mm | 4.8 |
| Example 1 | | | |
| Reference | Yes | Blade <5 mm, Shaft 5 mm | 4.7 |
| Example 2 | | | |
| Reference | No | Blade <5 mm, Shaft <5 mm | 4.0 |
| Example 3 | | | |

As shown in Table 1-1, it has become clear that in the present invention when the screw is rotating it is most preferable that the upper surface of the raw material powder be located at a position of at least about 10% and at most about 50% of the height of the interior of the casing.

This is also because, as shown in the results of Example 3 and Reference Example 3, at a position of about 10% or less of the height of the interior of the casing, the variation in the amount of eduction in the quantitative eduction test is small, and it is thought that the raw material powder is mixed or transported uniformly, and it can be presumed that as a result the bending strength of the manufactured honeycomb fired body became superior to that of the honeycomb structured body of Reference Example 3.

Also, as shown in the results of Examples 1 and 2 and Reference Examples 1 and 2, if the upper surface of the raw material powder is at a position of about 50% or less of the height of the interior of the casing, the wear of the agitation shaft observed after the continuous running is small, and this is attributed to the fact that the raw material powder is prevented from getting over the agitation shaft during mixing and transporting. Consequently, at a position of about 50% or less of the height, a superior durability of the screw can be achieved.

Moreover, in the present invention, it is preferable that the upper surface of the raw material powder be located at a position of at least about 40% and at most about 50% of the height of the interior of the casing when the screw is rotating. This is presumably because, as shown in the results of Examples, the variation in the quantitative eduction test is small.

### Examples 5 to 7, Reference Examples 4 to 5

Except that the value of the distance in between the edge portion of the agitating blade and the interior wall face of the casing had been set to the value shown in Table 2, the honeycomb fired body was manufactured in a manner identical to that of in Example 1.

Then, ‘evaluation of the agitation apparatus’, ‘strength measurement of the honeycomb fired body’, and ‘continuous running of the agitation apparatus’ was conducted in regard to the honeycomb fired body according to these Examples and Reference Examples. Observation as to whether or not the raw material powder has got to the other side over the agitation shaft during mixing and transporting has also been carried out.

The results are shown in Table 2. Moreover, the data of Example 1 has also been shown in Table 2 for the purpose of reference.

TABLE 2

| | | Distance | Variation | | | |
|---|---|---|---|---|---|---|
| | | between | in the | Raw Material | | |
| | Raw-Material | Agitation | Quantitative | Powder having | | three-Point |
| | Powder | Blade and | Eduction | got over the | | Bending |
| | Height | casing | Test | Agitation | | Strength |
| | (%) | (mm) | (σ) | Shaft? | Wear after continuous running | (MPa) |
| Example 1 | 40 | 5 | 12.6 | No | Blade <5 mm, Shaft <5 mm | 5.5 |
| Example 5 | 40 | 4 | 11.7 | No | Blade 5 to 10 mm, Shaft 5 to 10 mm | 5.2 |
| Example 6 | 40 | 8 | 13.9 | No | Blade <5 mm, Shaft <5 mm | 4.8 |
| Example 7 | 40 | 10 | 16.0 | No | Blade <5 mm, Shaft <5 mm | 4.9 |
| Reference | 40 | 3 | 18.8 | No | Blade 5 to 10 mm, Shaft 5 to 10 mm | 4.3 |
| Example 4 | | | | | | |
| Reference | 40 | 12 | 20.2 | No | Blade <5 mm, Shaft 5 to 10 mm | 4.1 |
| Example 5 | | | | | | |

As shown in Table 2, it has become clear that in the present invention it is preferable that the distance between the edge portion of the agitating blade and the interior wall face of the above-mentioned casing exceeds 3 mm but is about 10 mm or less.

This is presumably because, as the results of Example 4 and Reference Example 4 show, in cases in which the distance of both exceeds 3 mm, or in cases when the distance of both is about 10 mm or less, the variation in eduction amount in the quantitative eduction test is small, and consequently a superior strength of the manufactured honeycomb fired body can be achieved.

### Examples 8 to 10 and Reference Examples 6 to 7

Except that the value of the length from the edge portion of the tungsten carbide sprayed layer formed as the high hardness coat layer on the agitating blade was set to the value shown in Tables 3-1 and 3-2, the honeycomb fired body was manufactured in a manner identical to that of in Example 1.

Then, ‘evaluation of the agitation apparatus’, ‘strength measurement of the honeycomb fired body’, and ‘continuous running of the agitation apparatus’ was conducted in regard to the honeycomb fired body according to these Examples and Reference Examples. Also, the quantitative eduction test and the three-point bending strength test were also conducted after the 1 month period of continuous running. Observation as to whether or not the raw material powder has got to the other side over the agitation shaft during mixing and transporting has also been carried out.

The results are shown in Tables 3-1 and 3-2. Moreover, the data of Example 1 has also been shown in Tables 3-1 and 3-2 for the purpose of reference.

### Reference Examples 8 to 9

Except that buff polishing to the agitation shaft (Reference Example 8), and to the agitating blade (Reference Example 9), had not been conducted, the honeycomb fired body was manufactured in a manner identical to that of in Example 1.

Then, ‘evaluation of the agitation apparatus’, ‘strength measurement of the honeycomb fired body’, and ‘continuous running of the agitation apparatus’ was conducted in regard to the honeycomb fired body according to these Examples and Reference Examples. Also, the quantitative eduction test and the three-point bending strength test were also conducted after the 1 month period of continuous running. Observation as to whether or not the raw material powder has got to the other side over the agitation shaft thus spilling over during mixing and transporting has also been carried out.

The results are shown in Tables 3-1 and 3-2.

### Comparative Example 1

Except that the high hardness coat layer had not been formed onto the agitating blade, and the buff polishing to the agitating blade had not been carried out, the honeycomb fired body was manufactured in a manner identical to that of in Example 1.

Then, ‘evaluation of the agitation apparatus’, ‘strength measurement of the honeycomb fired body’, and ‘continuous running of the agitation apparatus’ was conducted in regard to the honeycomb fired body according to these Examples and Reference Examples. Also, the quantitative eduction test and the three-point bending strength test were also conducted after the 1 month period of continuous running. Observation as to whether or not the raw material powder has got to the other side over the agitation shaft during mixing and transporting has also been carried out.

The results are shown in Tables 3-1 and 3-2.

TABLE 3-1

| | | | | | | | Variation in |
|---|---|---|---|---|---|---|---|
| | | | | | High | Variation in | the |
| | | Distance | | Agitation | Hardness | the | Quantitative |
| | | between | | Shaft | Coat Layer | Quantitative | Eduction Test |
| | Raw-Material | Agitation | Sprayed | Surface | Surface | Eduction Test | (After |
| | Powder | Blade and | layer | Roughness | Roughness | (initial | Continuous |
| | Height | casing | Length | Ra | Ra | running) | Running) |
| | (%) | (mm) | (mm) | (μm) | (μm) | (σ) | (σ) |
| Example 1 | 40 | 5 | 10 | 4 | 8 | 12.6 | 13.1 |
| Example 8 | 40 | 5 | 7 | 4 | 8 | 13.1 | 16.0 |
| Example 9 | 40 | 5 | 15 | 4 | 8 | 12.6 | 14.0 |
| Example 10 | 40 | 5 | 20 | 4 | 8 | 12.6 | 15.3 |
| Reference | 40 | 5 | 5 | 4 | 8 | 12.1 | 16.3 |
| Example 6 | | | | | | | |
| Reference | 40 | 5 | 25 | 4 | 8 | 13.6 | 15.6 |
| Example 7 | | | | | | | |
| Reference | 40 | 5 | 10 | 8 | 8 | 14.5 | 17.8 |
| Example 8 | | | | | | | |
| Reference | 40 | 5 | 10 | 4 | 15 | 15.2 | 17.6 |
| Example 9 | | | | | | | |
| Comparative | 40 | 5 | — | 4 | 4(*) | 12.9 | 21.2 |
| Example 1 | | | | | | | |

(*)The value is surface roughness Ra of the agitation blade body on which buff polishing has been carried out.

TABLE 3-2

| | | | | three-Point |
|---|---|---|---|---|
| | | | three-Point | Bending Strength |
| | | | Bending Strength | (After |
| | Raw Material Powder | | (initial | Continuous |
| | having got over the | | running) | Running) |
| | Agitation Shaft? | Wear after continuous running | (MPa) | (MPa) |
| Example 1 | No | Blade <5 mm, Shaft <5 mm | 5.5 | 5.2 |
| Example 8 | No | Blade 5 to 10 mm, Shaft <5 mm | 5.1 | 4.6 |
| Example 9 | No | Blade <5 mm, Shaft <5 mm | 5.2 | 4.8 |
| Example 10 | No | Blade <5 mm, Shaft 5 to 10 mm | 5.2 | 4.3 |
| Reference | No | Blade 5 to 10 mm, Shaft <5 mm | 5.1 | 4.1 |
| Example 6 | | | | |
| Reference | Yes | Blade 5 mm, Shaft 5 to 10 mm | 5.0 | 4.2 |
| Example 7 | | | | |
| Reference | Yes | Blade <5 mm, Shaft 10 mm | 4.9 | 3.8 |
| Example 8 | | | | |
| Reference | Yes | Blade 5 mm, Shaft 5 to 10 mm | 4.9 | 4.2 |
| Example 9 | | | | |
| Comparative | No | Blade 5 to 10 mm, Shaft <5 mm | 5.0 | 3.5 |
| Example 1 | | | | |

As shown in Tables 3-1 and 3-2, it has become clear that in the present invention it is preferable that the length of the sprayed layer is at least about 7 mm and at most about 20 mm, and that buff polishing be carried out on each the agitation shaft and the agitating blade, and that the surface roughness Ra of the agitation shaft is about 4 μm or less, and the surface roughness Ra of the agitating blade is about 8 μm or less.

This is because, as can be clearly seen from the comparison of Examples and Reference Example 6, with the sprayed layer at a length of about 7 mm or less, the degree of wear of the agitating blade becomes small, and the variation in the quantitative eduction test of after the continuous running is prevented from increasing greatly in comparison to the initial value. As shown in the results of Reference Example 7, and with the sprayed layer at a length of about 20 mm or less, the lubricity of the agitating blade tends to have difficulty in degrading, and as a result it can be prevented for the raw material powder from getting over the agitation shaft during mixing and transporting, which in turn results in realizing a low degree of wear on the agitation shaft, by which superior durability can be achieved.

And as can be clearly seen from Examples 8 and 9 and Reference Examples 8 and 9, in cases in which the buff polishing is carried out on the agitation shaft and the agitating blade, the variation in the quantitative eduction test becomes small, and this trend becomes more notable after the continuous running. This is because in cases in which the buff polishing had not been carried out on the agitation shaft and the agitating blade, therefore the agitation shaft and the agitating blade have low surface roughness, the raw material powder tends to have difficulty in adhering to the agitation shaft and the agitating blade to prevent the mixing and transporting in a uniform manner from being inhibited, thereby making it difficult for wear to progress further thereon.

And as can be clearly seen from the comparison of Comparative Example with Example shown in Tables 3-1 and 3-2, in cases in which the sprayed layer is formed onto the agitating blade, wear will progress at an extremely slow rate, and the durability will become extremely superior. It has also become clear that even at continuous running for a period of 1 month, it is difficult for the agitating blade to be in a state that is no longer fit for use.

In particular, the present invention is effective in cases in which the raw material powder contains a hard ceramic powder such as silicon carbide powder. In such cases, it becomes unnecessary to frequently replace the agitating blade, so that the rate of halting of the operation upon replacing the agitating blade can be reduced, which leads to a presumption that operation efficiency and productivity can consequently be improved.

What is claimed as new and desired to be secured by letters patent of the united states is:

1. A method for mixing powder by conducting mixing and transporting of at least one kind of powder, comprising:
charging said at least one kind of powder into an agitation apparatus; and
translating said at least one kind of powder while mixing the powder by rotating an agitation shaft of said agitation apparatus, said agitation apparatus comprising:
a screw comprised of the agitation shaft and an agitating blade, said screw configured to rotate along with said agitation shaft as the center; and, a casing surrounding said screw,
wherein
either the entire body of said agitating blade is formed of a high hardness member, or, a high hardness coat layer is formed onto at least a portion of said agitating blade.

2. The method for mixing powder according to claim 1, wherein said at least one kind of powder includes an inorganic powder and an organic powder.

3. The method for mixing powder according to claim 2, wherein said inorganic powder is charged into the agitation apparatus in a manner to retain the inorganic powder inside said casing for a period longer than said organic powder.

4. The method for mixing powder according to claim 2, further comprising charging the organic powder into the agitation apparatus afterchargingsaidinorganicpowdercomprisingtwoormore kinds of powder of differing particle diameters, in descending order of the particle diameter.

5. The method for mixing powder according to claim 1, wherein a main component of said high hardness member and said high hardness coat layer comprises tungsten carbide.

6. The method for mixing powder according to claim 1, wherein a distance between an edge portion of said agitating blade and an interior wall face of said casing exceeds 3 mm but is about 10 mm or less.

7. The method for mixing powder according to claim 1, wherein said high hardness coat layer is formed on said agitating blade, said high hardness coat layer having a width of at least about 7 mm and at most about 20 mm.

8. The method for mixing powder according to claim 1, wherein a surface roughness Ra of said high hardness member or said high hardness coat layer is about 8 gm or less.

9. The method for mixing powder according to claim 1, wherein the charging amount of said at least one kind of powder is such that the upper surface of said at least one kind of powder lies at the same position as, or lower than, the lower end of said agitation shaft, when said screw is not in operation.

10. The method for mixing powder according to claim 1, wherein the charging amount of said at least one kind of powder is such that the upper surface of said at least one kind of powder lies at the position of at least about 10% and at most about 50% of the height of the interior of said casing, when said screw is rotating.

11. An agitation apparatus, which translates at least one kind of powder while mixing, comprising:
a screw comprised of an agitation shaft and an agitating blade, said screw rotating along with said agitation shaft as the center; and
a casing surrounding said screw,
wherein
either the entire body of said agitating blade is formed of a high hardness member, or, a high hardness coat layer is formed onto at least a portion of said agitating blade.

12. The agitation apparatus according to claim 11, wherein a main component of said high hardness member and said high hardness coat layer comprises tungsten carbide.

13. The agitation apparatus according to claim 11, wherein a distance between an edge portion of said agitating blade and an interior wall face of said casing exceeds 3 mm but is about 10 mm or less.

14. The agitation apparatus according to claim 11, wherein the diameter of said agitation shaft is at least about 60 mm and at most about 200 mm.

15. The agitation apparatus according to claim 11, wherein the width of said agitating blade is at least about 15 mm and at most about 30 mm.

16. The agitation apparatus according to claim 11, wherein said agitating blade is disposed substantially perpendicular to said agitation shaft.

17. The agitation apparatus according to claim 11, wherein saidagitatingbladeiswrappedaroundsaidagitationshaft in a spiral shape, and the space interval between the adjacent windings of said agitation shaft is set to at least about 50 mm and at most about 100 mm.

18. The agitation apparatus according to claim 11, wherein said high hardness coat layer is formed on said agitating blade, said high hardness coat layer having a width of at least about 7 mm and at most about 20 mm.

19. The agitation apparatus according to claim 11, wherein said high hardness coat layer is formed on said agitating blade, said high hardness coat layer formed by a spraying method.

20. The agitation apparatus according to claim 11, wherein a surface roughness Ra of said high hardness member or said high hardness coat layer is about 8 gm or less.

21. A method for manufacturing a honeycomb structured body comprising a honeycomb fired body, including:
carrying out a mixing-transportingprocess formixing and transporting a raw material powder containing at least one kind of a ceramic powder;
preparing a wet mixture by mixing further a liquid raw material with a mixture of said raw material powder, manufacturing a pillar shaped honeycomb molded body in which a number of cells are placed in parallel with one another in the longitudinal direction with a cell wall therebetween by molding said wet mixture, manufacturing said honeycomb fired body by firing said honeycomb molded body, said mixing-transporting process comprising:
charging said raw material powder into an agitation apparatus; and
translating said raw material powder while mixing the powder by rotating an agitation shaft of said agitation apparatus, said agitation apparatus comprising:
a screw comprised of the agitation shaft and an agitating blade, said screw configured to rotate along with said agitation shaft as the center; and, a casing surrounding said screw, wherein either the entire body of said agitating blade is formed of a high hardness member, or, a high hardness coat layer is formed onto at least a portion of said agitating blade.

22. The method for manufacturing a honeycomb structured body according to claim 21, wherein said raw material powder contains a ceramic powder and an organic powder.

23. The method for manufacturing a honeycomb structured body according to claim 22, wherein said ceramic powder is charged into the agitation apparatus in a manner to retain the ceramic powder inside said casing for a period longer than said organic powder.

24. The method for manufacturing a honeycomb structured body according to claim 22, further comprising charging the organic powder into the agitation apparatus after charging said ceramic powder comprising two or more kinds of ceramic powder of differing particle diameters, in descending order of the particle diameter.

25. The method for manufacturing a honeycomb structured body according to claim 21, wherein a main component of said high hardness member and said high hardness coat layer comprises tungsten carbide.

26. The method for manufacturing a honeycomb structured body according to claim 21, wherein a distance between an edge portion of said agitating blade and an interior wall face of said casing exceeds 3 mm but is about 10 mm or less.

27. The method for manufacturing a honeycomb structured body according to claim 21, wherein said high hardness coat layer is formed on said agitating blade, said high hardness coat layer having a width of at least about 7 mm and at most about 20 mm.

28. The method for manufacturing a honeycomb structured body according to claim 21, wherein a surface roughness Ra of said high hardness member or said high hardness coat layer is about 8 gm or less.

29. The method for manufacturing a honeycomb structured body according to claim 21, wherein the charging amount of said raw material powder is such that the upper surface of said raw material powder lies at the same position as, or lower than, the lower end of said agitation shaft, when said screw is not in operation.

30. The method for manufacturing a honeycomb structured body according to claim 21, wherein the charging amount of said raw material powder is such that the upper surface of said raw material powder lies at the position of at least about 10% and at most about 50% of the height of the interior of said casing, when said screw is rotating.
